(19) United States
(12) Patent Application Publication
(10) Pub. No.: US 2025/0372088 A1
(43) Pub. Date: Dec. 4, 2025

(54) ADAPTIVE SYSTEMS FOR AUTONOMOUS INFORMATION COLLECTION

(71) Applicant: Heirloom Media Technologies Inc., Los Angeles, CA (US)

(72) Inventors: Charles GREENE, Los Angeles, CA (US); Alexandre MASSONNEAU, Los Angeles, CA (US)

(21) Appl. No.: 19/222,862

(22) Filed: May 29, 2025

Related U.S. Application Data
(60) Provisional application No. 63/653,866, filed on May 30, 2024.

(51) Int. Cl. G10L 15/183; G06N 3/042; G10L 15/22; G10L 15/30; G10L 25/63; G10L 25/78

(52) U.S. Cl. CPC G10L 15/183; G06N 3/042; G10L 15/22; G10L 25/63; G10L 25/78; G10L 2015/227; G10L 15/30

(57) ABSTRACT

Systems and methods here may be used for receiving a recording of a user response to a prompt, transcribing, the recording to generate a transcript, analyzing, using a lightweight language model, the transcript and the prompt to determine whether the user response is complete, in response: retrieving, contextual information associated with the user, generating, using a large language model, a follow-up prompt based on the transcript, the prompt, and the contextual information, transmitting, the follow-up prompt to a user device, and receiving, a second recording of a user response to the follow-up prompt.

### CROSS REFERENCE

This application claims priority to U.S. Provisional Application 63/653,866, titled STREAMLINED INTERNET-BASED PERSONAL NARRATIVE COLLECTION, filed May 30, 2024, the entirety of which is hereby incorporated by reference.

### TECHNICAL FIELD

The present disclosure relates generally to system and methods for processing information through digital interfaces.

### SUMMARY

In some embodiments, a method includes receiving, by a processor, a recording of a user response to a prompt; transcribing, by the processor, the recording to generate a transcript; analyzing, by the processor using a lightweight language model, the transcript and the prompt to determine whether the user response is complete; in response to determining the user response is complete: retrieving, by the processor, contextual information associated with the user; generating, by the processor using a large language model, a follow-up prompt based on the transcript, the prompt, and the contextual information; transmitting, by the processor, the follow-up prompt to a user device; and receiving, by the processor, a second recording of a user response to the follow-up prompt.

In some embodiments, the contextual information includes historical data from previous recording sessions associated with the user.

In some embodiments, the method includes analyzing, by the processor, emotional content of the user response using a machine learning model.

In some embodiments, generating the follow-up prompt further includes utilizing, by the processor, the analyzed emotional content of the user response as input to the large language model to influence the generation of the follow-up prompt.

In some embodiments, the lightweight language model is optimized for low-latency processing of natural language input.

In some embodiments, the method includes storing, by the processor, the transcript and the follow-up prompt in a knowledge base associated with the user.

In some embodiments, generating the follow-up prompt includes identifying, by the large language model, key topics mentioned in the transcript; and formulating a question to elicit additional details about at least one of the key topics.

In some embodiments, the method includes detecting, by the processor, a natural pause in the user response; and wherein analyzing the transcript and the prompt to determine whether the user response is complete is performed in response to detecting the natural pause.

In some embodiments, a system includes a processor; and a memory storing instructions that, when executed by the processor, cause the processor to: receive a recording of a user response to a prompt; transcribe the recording to generate a transcript; analyze, using a lightweight language model, the transcript and the prompt to determine whether the user response is complete; in response to determining the user response is complete: retrieve contextual information associated with the user; generate, using a large language model, a follow-up prompt based on the transcript, the prompt, and the contextual information; transmit the follow-up prompt to a user device; and receive a second recording of a user response to the follow-up prompt.

In some embodiments, the contextual information includes historical data from previous recording sessions associated with the user.

In some embodiments, the instructions further cause the processor to analyze emotional content of the user response using a machine learning model.

In some embodiments, generating the follow-up prompt further includes utilizing the analyzed emotional content of the user response as input to the large language model to influence the generation of the follow-up prompt.

In some embodiments, the lightweight language model is optimized for low-latency processing of natural language input.

In some embodiments, the instructions further cause the processor to store the transcript and the follow-up prompt in a knowledge base associated with the user.

In some embodiments, generating the follow-up prompt includes: identifying, by the large language model, key topics mentioned in the transcript; and formulating a question to elicit additional details about at least one of the key topics.

In some embodiments, the instructions further cause the processor to detect a natural pause in the user response; and wherein analyzing the transcript and the prompt to determine whether the user response is complete is performed in response to detecting the natural pause.

In some embodiments, a non-transitory computer-readable medium storing instructions that, when executed by a processor, cause the processor to perform operations including receiving a recording of a user response to a prompt; transcribing the recording to generate a transcript; analyzing, using a lightweight language model, the transcript and the prompt to determine whether the user response is complete; in response to determining the user response is complete: retrieving contextual information associated with the user; generating, using a large language model, a follow-up prompt based on the transcript, the prompt, and the contextual information; transmitting the follow-up prompt to a user device; and receiving a second recording of a user response to the follow-up prompt.

In some embodiments, the contextual information includes historical data from previous recording sessions associated with the user.

In some embodiments, the operations further include analyzing, by the processor, emotional content of the user response using a machine learning model.

In some embodiments, generating the follow-up prompt further includes: utilizing, by the processor, the analyzed emotional content of the user response as input to the large language model to influence the generation of the follow-up prompt.

### BRIEF DESCRIPTION OF THE DRAWINGS

The accompanying drawings, which are incorporated in and form a part of the specification, illustrate the embodiments of the invention and together with the written description serve to explain the principles, characteristics, and features of the invention. Various aspects of at least one example are discussed below with reference to the accompanying drawings, which are not intended to be drawn to scale. In the drawings:

FIG. 1 depicts a block diagram of a recording system in accordance with an embodiment.

FIG. 2 depicts an illustrative flowchart of a process for generating and managing interview prompts in accordance with an embodiment.

FIG. 3 depicts an authentication method for secure access to a recording interface in accordance with an embodiment.

FIG. 4 depicts an illustrative block diagram of a recording method distributed between devices in accordance with an embodiment.

FIGS. 5A and 5B depict a block diagrams of data flow for recording information with real-time processing in accordance with an embodiment.

FIG. 6 depicts an illustrative flowchart for a method for processing media streams in accordance with an embodiment.

FIG. 7A depicts an illustrative secondary communication user interface for initiating a recording session in accordance with an embodiment.

FIG. 7B depicts an exemplary user interface for recording responses during an interview session in accordance with an embodiment.

FIG. 8A depicts an illustrative recording user interface displaying a recorded image and question prompt in accordance with an embodiment.

FIG. 8B depicts a recording user interface in a paused state with resume and done options in accordance with an embodiment.

FIG. 9 illustrates a diagram of an example computer system in accordance with an embodiment.

### DETAILED DESCRIPTION

Digital technologies have opened new avenues for information collection, allowing for remote interviews and self-recorded stories. However, many existing digital platforms present their own challenges. Some require users to create accounts and remember login credentials, which can be a barrier, especially for older individuals or those less familiar with technology. Other systems may necessitate the installation of specialized software or apps, further complicating the process for potential participants.

The quality and depth of collected information can vary widely depending on the prompts provided. Without guidance, users may struggle to structure their thoughts or may overlook significant details that could enrich their narratives. Additionally, the impersonal nature of some digital interfaces may fail to create the rapport and trust typically established in face-to-face interviews, potentially leading to less engaging or detailed responses.

Privacy and data security concerns also present challenges in digital information collection. Users may be hesitant to share personal information if they are uncertain about how their information will be stored, used, or protected. This is particularly relevant when dealing with sensitive or emotionally charged memories.

Existing systems for digital information collection may inadvertently introduce bias into the process through their use of predetermined or human-generated prompts and questions. These pre-set queries may reflect the assumptions, perspectives, or cultural biases of their creators, potentially steering respondents towards certain types of answers or limiting the scope of the information collected. In some cases, the language used in prompts may be unintentionally exclusionary or fail to resonate with diverse populations, leading to incomplete or skewed data collection.

Furthermore, human-generated follow-up questions during digital interviews may be influenced by the interviewer's own preconceptions or areas of interest, potentially overlooking important aspects of the user's experience. This can result in a narrowing of the narrative focus, where certain themes are emphasized while others are inadvertently minimized or omitted entirely. The rigidity of some digital systems in following a predetermined script may also prevent the natural flow of conversation and limit the ability to explore unexpected but potentially valuable tangents in a person's story.

Furthermore, the process of analyzing and deriving insights from collected information can be time-consuming and labor-intensive. Manual review of hours of recorded content may not be feasible for large-scale projects, limiting the potential for broader cultural or historical studies based on these personal accounts.

As the field of digital storytelling and oral history collection continues to evolve, there is a growing need for systems that can address these various challenges. Ideally, such systems would combine ease of use with sophisticated machine learning capabilities, while also ensuring the privacy and security of provided information.

An adaptive digital system for autonomous information collection may provide a comprehensive solution for capturing, processing, and preserving personal information, testimonials, expertise, reflections, and knowledge without requiring human interviewer intervention. The system may integrate several key components to create a seamless and user-friendly experience for users while ensuring high-quality recordings and meaningful content generation.

The system may incorporate a prompt management component that generates and prioritizes questions tailored to each user's unique experiences and context. An authentication mechanism may allow secure access to the recording interface without requiring traditional login credentials or software downloads. The recording interface may operate entirely within a web browser, supporting both audio and video capture across a wide range of devices.

A real-time interview component analyzes ongoing recordings, detects natural pauses or information boundaries, and generates contextually relevant follow-up prompts. The system may also include robust recording processing capabilities, handling tasks such as transcription, content analysis, and knowledge extraction.

In some aspects, the system may be able to support multiple simultaneous recording sessions. This scalability allows for efficient collection of information from numerous users concurrently, making it suitable for large-scale oral history projects, social research initiatives, or organizational knowledge preservation efforts.

By combining these components, the system enables the autonomous collection of information at scale, while maintaining the depth and nuance typically associated with traditional interviews. The system may continuously learn and adapt based on accumulated knowledge, improving its ability to elicit meaningful responses and create comprehensive information records over time.

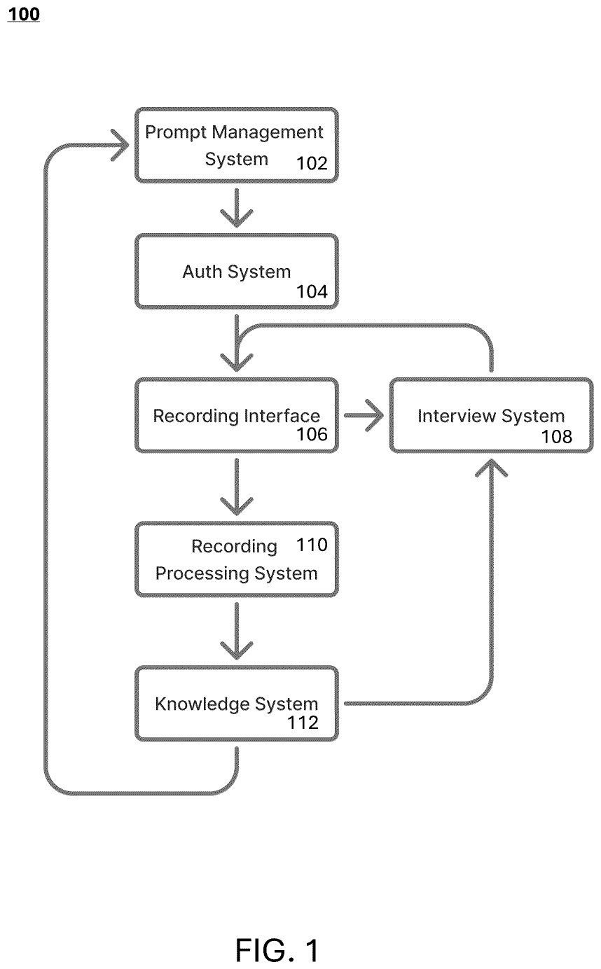

FIG. 1 illustrates a block diagram of a recording system 100. The recording system 100 may include a prompt management system 102, an authentication system 104, a recording interface 106, an interview system 108, a recording processing system 110, and a knowledge system 112.

A prompt management system 102 may generate and manage prompts for guiding the recording process. The prompt management system 102 may be configured to generate prompts using a machine learning model.

The prompt management system 102 may utilize various types of machine learning models to generate and manage prompts effectively. In some cases, natural language processing (NLP) models, such as transformer-based architectures like BERT (Bidirectional Encoder Representations from Transformers) or GPT (Generative Pre-trained Transformer), may be employed. These models may understand context and generate human-like text, allowing for the creation of prompts that are contextually relevant and engaging.

Recurrent Neural Networks (RNNs) or Long Short-Term Memory (LSTM) networks may be used in some implementations to process sequential data and maintain context over longer periods. These models can be particularly useful for understanding the flow of a conversation and generating follow-up prompts that build upon previous responses. RNNs and LSTMs may offer advantages in capturing temporal dependencies and maintaining coherence throughout an extended interview session.

In some aspects, the system may incorporate reinforcement learning models to optimize prompt selection and generation over time. These models can learn from user engagement metrics, response quality, and other feedback signals to improve the effectiveness of prompts. Reinforcement learning may allow the system to adapt its prompting strategy based on real-time performance, potentially leading to more engaging and productive interview sessions.

The machine learning models used in the prompt management system 102 may undergo fine-tuning to adapt to specific domains or use cases. This fine-tuning process may involve training the models on domain-specific datasets, such as historical interviews, expert knowledge bases, or curated collections of personal narratives. By fine-tuning the models, the system may generate prompts that are more relevant to particular topics, cultural contexts, or storytelling styles.

In some implementations, the fine-tuning process may also incorporate transfer learning techniques. This approach allows the system to leverage knowledge gained from large, general-purpose language models and adapt it to more specialized tasks or domains. Transfer learning may enable the prompt management system 102 to achieve high performance with relatively small amounts of domain-specific training data, potentially improving efficiency and reducing the need for extensive manual curation of training datasets.

The system may also employ ensemble methods, combining multiple machine learning models to improve overall performance and robustness. Ensemble techniques, such as bagging, boosting, or stacking, may allow the prompt management system 102 to leverage the strengths of different model architectures and mitigate individual model weaknesses. This approach may lead to more diverse and effective prompt generation, potentially capturing a wider range of narrative elicitation strategies.

An authentication system 104 may handle user authentication and access control. The authentication system 104 may provide secure access to the recording interface 106 without requiring traditional login credentials.

In some implementations, the authentication system 104 may generate a unique URL for each recording session. This URL may contain encoded session metadata, such as a user identifier, session timestamp, and other relevant information. The system may then apply a digital signature to the URL using a secret key known only to the server. This digital signature may help ensure the integrity and authenticity of the URL.

When a user attempts to access the recording interface 106 using the provided URL, the authentication system 104 may verify the digital signature and validate the encoded metadata. This process may include checking that the URL has not expired and has not been previously used. If the validation is successful, the system may issue a short-lived JSON Web Token (JWT) that grants access to the recording interface 106 for the specific session.

The use of cryptographically secure URLs may offer several advantages. It may eliminate the need for users to remember and enter login credentials, potentially increasing participation rates. The system may also generate and distribute these secure URLs through various channels, such as email or text message, allowing for flexible and context-appropriate delivery of access links. Additionally, the short-lived nature of these URLs and their associated tokens may provide an added layer of security, limiting the window of opportunity for potential unauthorized access.

A recording interface 106 captures audio and video input from users. The recording interface 106 may operate entirely within a web browser, eliminating the need for software downloads or installations.

The recording interface 106 may leverage web technologies to enable seamless audio and video capture within a browser environment. In some implementations, the system may utilize the MediaRecorder API to access and record audio streams directly from the user's device. For video and/or audio capture, the system may employ the getUserMedia ( ) method of the MediaDevices interface, allowing access to the device's camera. These APIs, combined with HTML5 capabilities, may enable the recording interface 106 to function across various devices and browsers without requiring additional plugins or software installations.

In some cases, the system may use WebRTC (Web Real-Time Communication) technology to facilitate real-time audio and video streaming between the user's device and the remote server. WebRTC may allow for low-latency, peer-to-peer connections, potentially improving the responsiveness of the interview process. In alternative embodiments, the system may also utilize Web Workers to handle computationally intensive tasks, such as audio processing or local transcription, in the background, ensuring a smooth user experience even on less powerful devices. Additionally, the recording interface 106 may employ responsive design techniques and progressive enhancement to adapt to different screen sizes and device capabilities, providing a consistent experience across desktop and mobile platforms.

In some implementations, the system may offer alternatives to a web-based application, such as stand-alone applications. These alternatives may include native mobile applications developed for specific platforms like iOS or Android, which can leverage device-specific features and potentially offer enhanced performance. Desktop applications for Windows, macOS, or Linux may also be developed, providing a dedicated interface for users who prefer a more traditional software experience. These stand-alone applications may offer advantages such as offline functionality, deeper integration with device hardware, and potentially more robust security features. In some cases, the system may implement a hybrid approach, combining elements of web-based and native applications to balance cross-platform compatibility with platform-specific optimizations. This flexibility in deployment options may allow the system to cater to a wider range of user preferences and technical requirements, potentially increasing adoption and usability across diverse user groups.

An interview system 108 may manage the interview process and interact with both the recording interface 106 and knowledge system 112. The interview system 108 may analyze ongoing recordings and generate contextually relevant follow-up prompts in real-time.

The interview system 108 may perform various types of analysis on ongoing recordings to enhance the interview process and generate more meaningful responses. In some implementations, the system may employ real-time speech recognition to transcribe the user's responses as they are being recorded. This transcription may then undergo natural language processing to identify key topics, themes, and sentiment within the information.

The system may also incorporate audio analysis techniques to detect emotional responses from the user. This may involve examining acoustic features such as pitch, tone, speaking rate, and voice quality to infer the user's emotional state. In some cases, if video recording is enabled, the system may utilize computer vision algorithms to analyze facial expressions and body language, providing additional cues about the user's emotional state.

Based on the detected emotional responses, the interview system 108 may adapt its prompting strategy. For instance, if the system detects heightened interest or excitement in the user's voice when discussing a particular topic, it may generate follow-up prompts to explore that subject in greater depth. The system may prompt the user for more information associated with positive emotional responses, encouraging them to elaborate on experiences that evoke joy, nostalgia, or enthusiasm.

Conversely, the system may be designed to recognize signs of discomfort or distress in the user's responses. In such cases, the interview system 108 may generate prompts that offer words of comfort or acknowledgment of the user's feelings. For example, if a user becomes upset while recounting a difficult memory, the system may respond with a prompt like, “That sounds like it was a challenging experience. Would you like to take a moment before we continue, or is there another aspect of your story you′d prefer to discuss?”

The interview system 108 may also be programmed to avoid or carefully navigate topics that elicit strong negative emotional responses, such as anger or severe distress. If the system detects these emotions, it may generate prompts that gently steer the conversation towards more neutral or positive subjects, ensuring the user's comfort and well-being throughout the interview process.

A recording processing system 110 may process the captured recordings. The recording processing system 110 may include one or more of standardization, packaging, and transcription phases. In the standardization phase, the system may convert recordings to a uniform format. The recording processing system 110 may convert audio recordings from various input formats such as MP3, WAV, or AAC into a standardized format like FLAC or Opus for consistent processing and storage. During the packaging phase, the system may encapsulate the standardized audio files along with associated metadata into container formats such as MKV or MP4, potentially enabling efficient streaming and playback across different devices and platforms. The packaging phase may prepare the recordings for storage and playback. Packaging may include encapsulating the standardized audio or video files along with associated metadata into container formats such as MKV or MP4. This process may facilitate efficient streaming, playback across different devices and platforms, and organization of the recorded content for long-term storage and retrieval. The transcription phase may convert audio to text for further analysis. In some embodiments, transcription may also include translation.

A knowledge system 112 may analyze recorded content and provide feedback to both the interview system 108 and prompt management system 102. The knowledge system 112 may use large language models for fact extraction and insight extraction. This analysis may help refine future prompts and improve the overall quality of collected information.

Large language models may process the transcribed text of user responses, utilizing their deep understanding of language patterns and contextual relationships to identify key information. In some implementations, the system may use named entity recognition techniques to extract specific facts such as names, dates, locations, and events mentioned in the narrative. The large language model may also perform sentiment analysis and topic modeling to derive insights about the user's emotional state, interests, and the overall themes present in the information.

In addition to fact extraction, the knowledge system 112 may leverage the large language model's ability to generate text to summarize and interpret the collected information. This process may involve identifying overarching themes, drawing connections between different parts of the story, and inferring implicit information based on context. The system may also compare extracted facts and insights across multiple recordings from the same user or within a specific project, uncovering patterns or inconsistencies that could inform future prompts or guide the direction of subsequent interview sessions.

The components of the recording system 100 may be arranged in a circular flow where information moves from the prompt management system 102 through the recording process and back through the knowledge system 112, creating an iterative recording and learning cycle. This architecture enables the system to continuously improve its ability to elicit meaningful responses and create comprehensive information records over time.

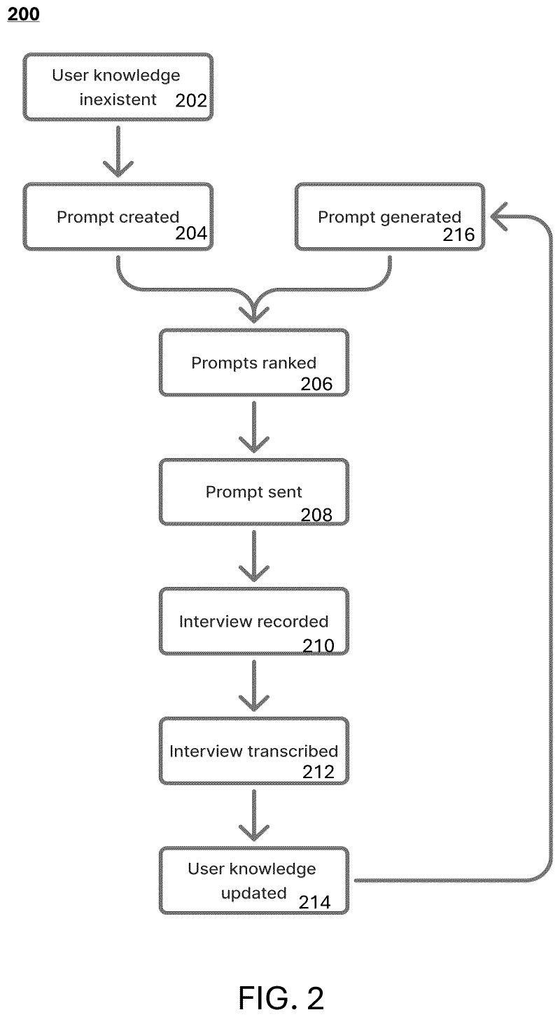

FIG. 2 illustrates a method 200 for generating and managing interview prompts in the recording system 100. The method 200 may be implemented by the prompt management system 102 in conjunction with other components of the recording system 100.

The method 200 may include determining 202, whether previous user knowledge exists. This determination may occur when a new user begins interacting with the recording system 100 or when a new project is initiated.

The method 200 may include creating 204 an initial prompt. This initial prompt may be generated based on input from a secondary user which requested the information collection. In some implementations, the system may allow users to initiate interviews based on custom prompts or media inputs. A user may submit an initial question or upload various types of media, such as photographs, audio clips, video segments, or unstructured data, through a user interface. The system may process these inputs to generate relevant interview prompts. For instance, if a user uploads a family photograph, the system may analyze the image content and create questions about the people, location, or events depicted. Similarly, for audio or video inputs, the system may extract key themes or topics to form the basis of interview questions. In cases where unstructured data is provided, such as journal entries or letters, the system may employ natural language processing techniques to identify significant elements and formulate appropriate prompts. This feature may enable users to tailor the experience to specific memories, events, or themes they wish to explore, potentially enhancing the depth and personal relevance of the collected information.

The method 200 may include ranking 206 multiple prompts to determine an optimal prompt. The ranking may be based on various factors such as relevance to the user, potential for eliciting detailed and/or emotional responses, and/or alignment with project goals.

The method 200 may include sending 208 the highest-ranked prompt to the recording interface 106. The authentication system 104 may be involved in this step to ensure secure transmission of the prompt.

The method 200 may include recording 210 the user's response to the prompt via the recording interface 106. This may involve audio and/or video recording, depending on the capabilities of the user's device and the settings of the recording system 100.

The method 200 may include transcribing 212 the recorded audio into text via the recording processing system 110. This transcription may be performed using speech recognition algorithms or other natural language processing techniques.

The method 200 may include updating 214, by the knowledge system 112, a knowledge base based on the processed response. The knowledge base may contain information about the user, their experiences, and their information style. This updated knowledge may be used to generate contextually relevant follow-up prompts in future iterations of the method 200.

The method 200 may include generating 216, by the prompt management system 102, a new prompt based on the updated user knowledge. This new prompt may be more tailored to the user's experiences and information style, potentially leading to richer and more detailed responses in subsequent iterations.

The method 200 may then loop back to the rank step 206, creating an iterative process for continuous improvement of prompt generation and management. This iterative approach may allow the recording system 100 to adapt to each user's unique information and provide increasingly relevant and engaging prompts over time.

In some embodiments, multiple steps of the method may be performed by a single machine learning algorithm.

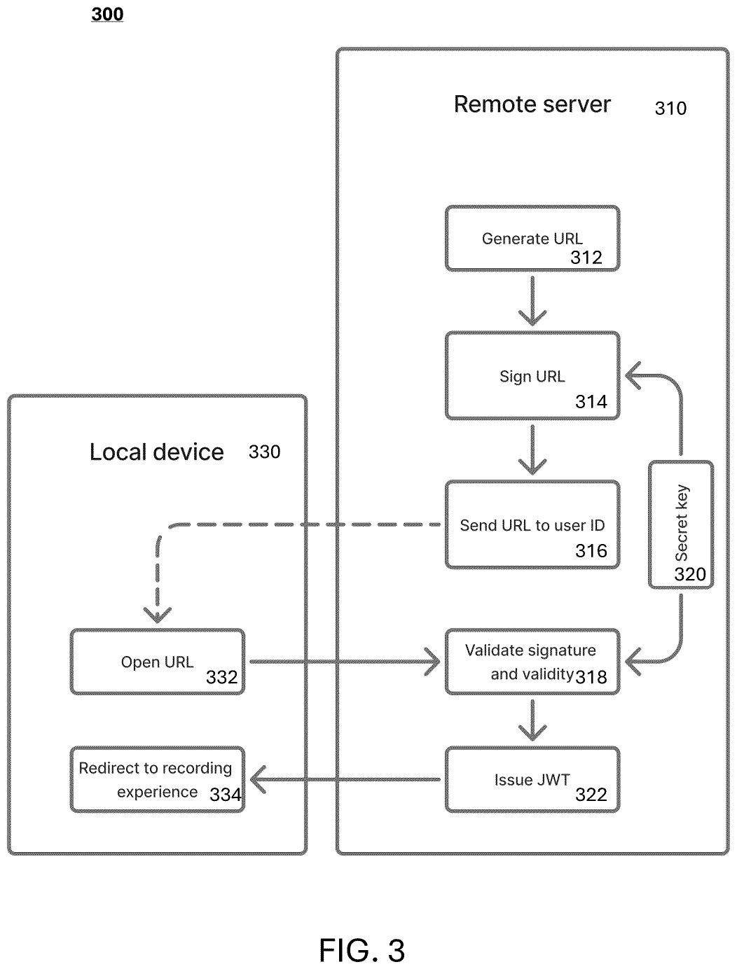

FIG. 3 illustrates an authentication method 300 that enables secure access to the recording interface 106 without requiring manual login credentials. The authentication method 300 may include components distributed between a remote server 310 and a local device 330 associated with the user.

The remote server 310 may include several processing components arranged in sequence. The method 300 may include generating 312 a URL containing session metadata and an expiration timestamp. The URL may be signed 314 with a digital signature using a secret key 320. As a result, the URL may be a cryptographically secure link. The signed URL may be transmitted 316 to the intended recipient over a network connection. The URL may be sent to the user via a secondary communication channel associated with the user, such as email or text message.

When the URL is accessed, the method 300 may include validating 318 the digital signature and confirming that the expiration timestamp has not passed. This validation process may ensure the integrity and timeliness of the secure access link. The method 300 may include generating 322 a token (e.g., a JSON Web Token (JWT)).

The local device may open 322 the received URL when activated by the user. Based on successful validation by the remote server 310, the user may be redirected 334 to the recording interface 106 using the issued token for authentication.

In some cases, the authentication method 300 may utilize WebLock API to ensure only one recording process runs at a time within a browser on the local device 330. This prevents multiple simultaneous recording sessions from interfering with each other.

The authentication method 300 may provide a secure and frictionless way for users to access the recording interface 106 without the need for traditional login credentials or account creation. By using digitally signed URLs with expiration timestamps, the method may ensure that access links remain secure and time-limited.

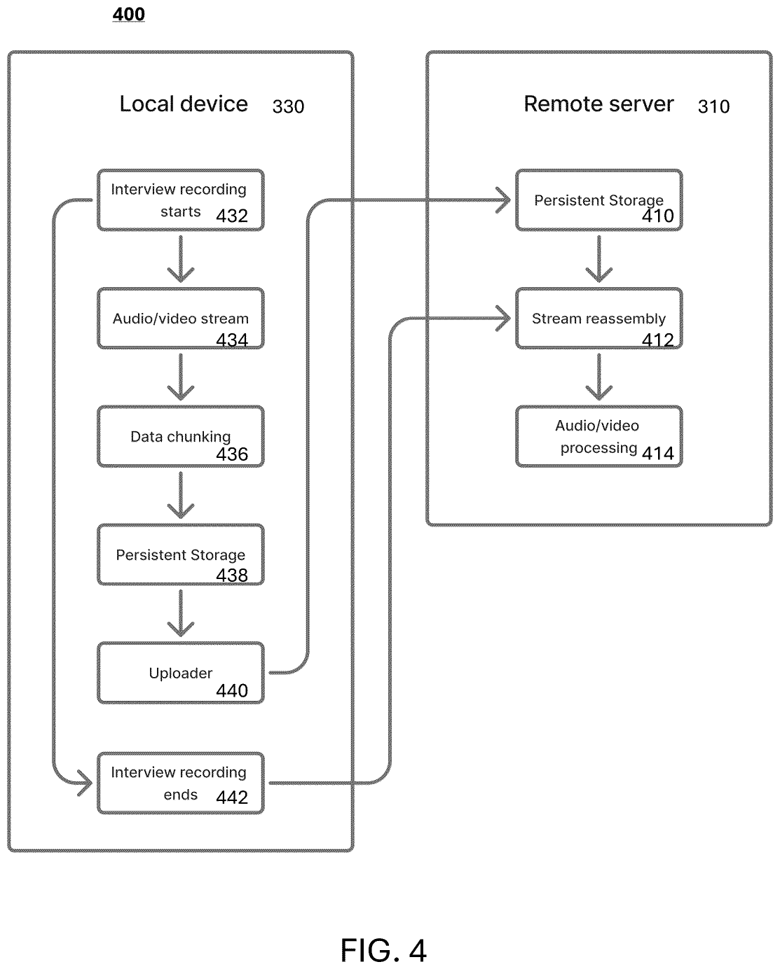

FIG. 4 illustrates a block diagram of a recording method 400 that includes elements distributed between a local device 330 and a remote server 310. The recording method 400 may be implemented as part of the recording system 100 and may interact with other components such as the recording interface 106 and the recording processing system 110.

The recording method 400 may include starting 432 the recording on the local device 330. This may initiate the recording process when a user interacts with the recording interface 106. In some cases, the recording interface 106 may detect the capabilities of the local device 330 and adjust accordingly (e.g., audio-only or video capture).

The local device 330 may generate 434 an audio and/or video stream. This stream may be a continuous flow of media data captured by the local device 330. The stream may utilize the HTML5 MediaRecorder API to capture encoded media data at fixed intervals.

The local device 330 may perform data chunking 436 to divide the audio or video stream into smaller data segments. This chunking process may help manage large amounts of data and facilitate efficient data transfer between the local device 330 and the remote server 310. In some cases, the chunk size may be optimized based on factors such as network conditions and device capabilities.

The local device 330 may use IndexedDB for in-browser data persistence. Each chunk of media data may be stored as a separate entry in the IndexedDB, allowing for efficient management and retrieval of recorded data. This local storage may enable the recording method 400 to support pause and resume functionality, as partially recorded data can be retained even if the recording process is interrupted.

The local device 330 may upload 440 the chunked data to the remote server 310. This upload process may occur in real-time, with chunks being sent to the remote server 310 as they are created and stored locally. The real-time chunked uploading may minimize the risk of data loss and reduce the delay between recording and processing.

The recording method 400 ending 442 the recording on the local device 330. This may be triggered when the user chooses to stop the recording or when a predetermined recording duration is reached. Alternatively, the system may automatically end or pause the recording based on a disruption to network or remote server 310 operations.

The remote server 310 may receive and persistently store 410 the uploaded data chunks. This may ensure that all uploaded chunks are securely saved before any further processing occurs.

The remote server 310 may reassemble 412 the uploaded data chunks into a continuous recording. This process may involve ordering the chunks based on their sequence and combining them into a single, coherent media file.

In some embodiments, the remote server 310 may process 414 the reassembled recording. These operations may include transcribing the continuous recording and analyzing the transcription for content and context. The transcription may be performed using speech recognition algorithms, while the analysis may involve natural language processing techniques to extract meaningful information from the recorded content.

The components utilized in the recording method 400 may interact with other components of the recording system 100. For example, the authentication system 104 may ensure that only authorized users can initiate and upload recordings. The interview system 108 may use the processed recordings to generate contextually relevant follow-up prompts. The knowledge system 112 may analyze the processed recordings to update its understanding of the user and improve future prompt generation.

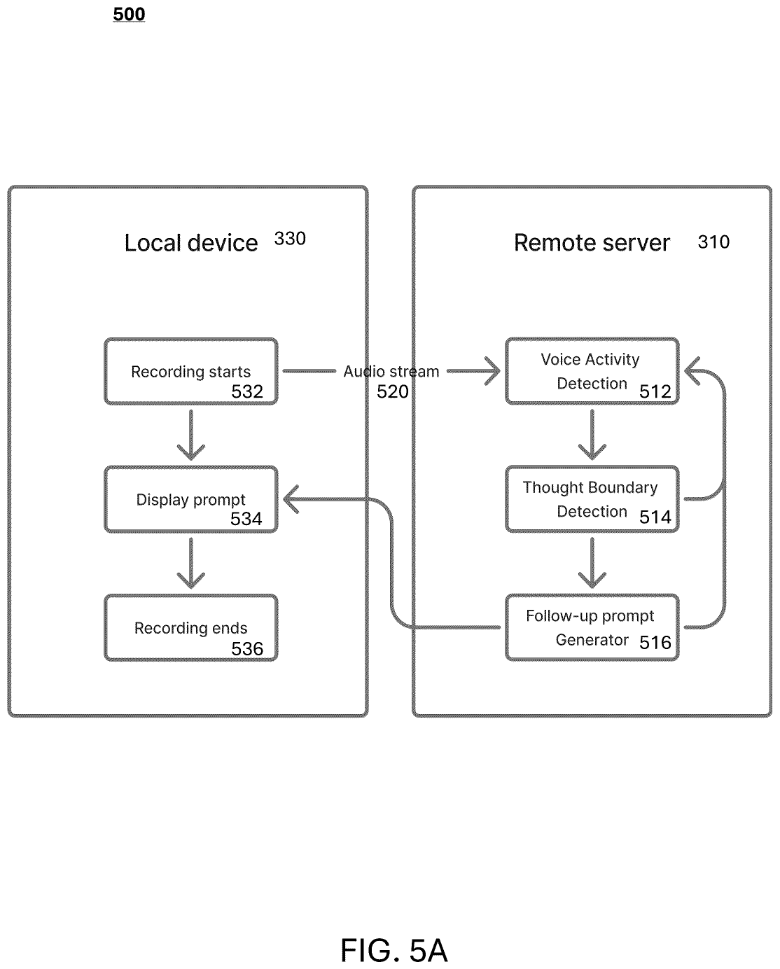

FIG. 5A illustrates a data flow 500 that operates between a local device 330 and a remote server 310. The data flow 500 may be implemented as part of the interview system 108 within the recording system 100, providing a real-time adaptive interviewing loop that generates follow-up prompts based on ongoing speech analysis.

The data flow 500 may include starting 532 the recording on the local device 330. This may be initiated when a user interacts with the recording interface 106. The system may establish a WebSocket connection with a third-party transcription service using a signed URL. Once recording begins, an audio stream 520 is generated and transmitted from the local device 330 to the remote server 310. Audio may be captured from the user's microphone and streamed in slices (e.g., 100 ms slices) via the MediaRecorder API. Each audio slice may be immediately forwarded over the WebSocket, enabling the transcription service to emit interim transcript chunks in near real-time. These chunks may be timestamped and stored locally in the browser's IndexedDB as TranscriptChunk objects, tagged with the current session ID and relative time offset.

The remote server 310 may perform voice activity detection 512 on the incoming audio stream 520. The detection 512 may include algorithms to identify periods of speech within the audio stream 520, distinguishing between active speech and background noise or silence.

In some implementations, the voice activity detection 512 may employ various algorithms to identify speech within the audio stream 520. These algorithms may include energy-based methods that analyze the signal's amplitude over time, zero-crossing rate techniques that examine the frequency of sign changes in the signal, or spectral analysis approaches such as Mel-frequency cepstral coefficients (MFCCs). Machine learning models, such as Gaussian Mixture Models (GMMs) or neural networks, may also be utilized to classify audio segments as speech or non-speech. In some cases, the system may incorporate adaptive thresholding techniques to adjust sensitivity based on background noise levels or speaker characteristics. Additionally, the voice activity detection 512 may leverage contextual information, such as the expected duration of speech segments or typical pause patterns, to improve accuracy in distinguishing between speech and non-speech audio. The choice of algorithm may depend on factors such as computational resources, required accuracy, and the specific characteristics of the recording environment.

The remote server 310 may perform thought boundary detection 514. The detection may include analyzing the patterns of speech and pauses to identify logical breaks or transitions in the user's information. These thought boundaries may indicate when a user has completed a particular idea or segment.

The remote server 310 may produce 516 follow-up prompts based on the analyzed audio. Prompts may be generated using natural language processing techniques to understand the content and context of the user's speech. The follow-up prompt may be based on (e.g., weighted towards) the most recent segment. In some cases, the remote server 516 may utilize the knowledge system 112 to retrieve relevant information about the user's previous responses or known facts, helping to generate more personalized and contextually appropriate prompts.

The generated prompts may be sent back to the local device 330, where they are 534 presented 534 to the user. The prompts may be presented as some combination of text, audio, imagery, or video. Multimedia elements of the prompt may be pulled from the knowledge system 112 or generated (e.g., using a transformer).

The data flow 500 may include ending 536 the recording on the local device 330. Throughout the process, the audio stream 520 may maintain a continuous connection between the local device 330 and remote server 310, allowing for real-time processing and prompt generation.

FIG. 5B illustrates an illustrative data flow 560 that operates between a local device 330 and a remote server 310, incorporating enhanced real-time transcription capabilities. This alternative implementation may provide improved responsiveness and accuracy in generating contextually relevant follow-up prompts during the recording session.

The data flow 550 may include starting 532 the recording on the local device 330. The audio stream 520 may be transmitted to a dedicated transcription service 550. The transcription service 550 may receive the audio stream 520 and perform real-time transcription 552 to convert speech to text. The transcription service 550 may generate a transcript stream 554 containing timestamped text segments that correspond to the user's spoken responses. This transcript stream 554 may be transmitted back to the local device 330 and/or the remote server 310 for further processing.

The local device 330 may include persistent storage 538 for maintaining recording data (e.g., the transcription stream 554 from the transcription service 550) and session state information. A silence detector 540 may monitor the audio stream 520 to identify periods of silence or reduced speech activity. Local silence detection may complement and/or replace remote voice activity detection and provide additional input for determining appropriate timing for prompt generation.

The remote server 310 may receive the analyzed and transcribed data.

The remote server 310 may perform thought boundary detection 514. The detection may include analyzing the patterns of speech and pauses to identify logical breaks or transitions in the user's information. These thought boundaries may indicate when a user has completed a particular idea or segment.

In some embodiments, the remote server 310 may perform thought boundary detection 514 using the transcript stream 554 rather than relying solely on audio analysis. By analyzing the textual content of the user's responses, the thought boundary detection 514 may more accurately identify logical breaks, topic transitions, and completion of ideas within the user's narrative. This text-based analysis may provide enhanced context understanding compared to audio-only processing.

The follow-up prompt generator 516 may utilize the transcript stream 554 to create more contextually relevant prompts. By having access to the actual words and phrases used by the user, the prompt generator 516 may identify specific topics, themes, or details mentioned in the response and generate targeted follow-up questions that encourage deeper exploration of those elements. The follow-up prompt generator 516 may focus on a recent thought derived from the user data. The local device 330 may display 534 the generated prompts to the user.

In some cases, the system may adapt to different speech patterns or information styles. For example, the boundary detection parameters may be adjusted based on the user's speaking pace or tendency to pause. Similarly, the machine learning models may refine prompt generation strategies based on the types of prompts that have elicited detailed and/or emotional responses from the user in past interactions.

The system may include a background timer which monitors the incoming transcript stream. If no new words are received for a threshold period (e.g. 1000 ms), the client may infer a possible speech pause.

The prompt management system 102 may provide initial prompts or guidelines for follow-up question generation. The system may package the most recent prompt along with the corresponding recording transcript as a structured payload to the backend API. The recording processing system 110 may use the identified thought boundaries to segment the recorded audio for more efficient processing and analysis.

The backend may invoke a latency-optimized, lightweight language model to determine whether the user has completed a thought. This “completion classifier” may receive the last prompt and all subsequent utterances, formatted as a dialogue, and return a binary decision (yes or no) indicating whether it is contextually appropriate to present a follow-up prompt. If the result is negative, no action is taken and the client continues listening for new speech.

If the classifier returns yes, the system may fetch long-term contextual information about the user including insights from previous recordings submitted by the user and known facts about the user. A full-scale LLM may then be invoked to generate a contextually relevant follow-up question. This model may use both the immediate conversation and historical user context to construct a new prompt that aims to elicit further informational depth, specificity, or emotional reflection. If no prompt is deemed suitable, the model may return an empty response.

When a follow-up prompt is returned to the client, the interface may display a subtle call-to-action to advance to the next prompt, preserving the conversational flow without interrupting the user. If the user proceeds, the prompt may be recorded locally as a new TranscriptChunk of type PROMPT and stored in IndexedDB with the associated timestamp. A new prompt event may be pushed to the recording event stream.

The system may support pause/resume behavior. When the user pauses recording, the client may close the WebSocket and retain all transcription data. Upon resume, a new signed URL may be requested, a new WebSocket opened, and all subsequent transcripts offset appropriately to maintain continuity. In the event of transcription service failure, the system may gracefully degrade by suspending prompt suggestions until the session is resumed.

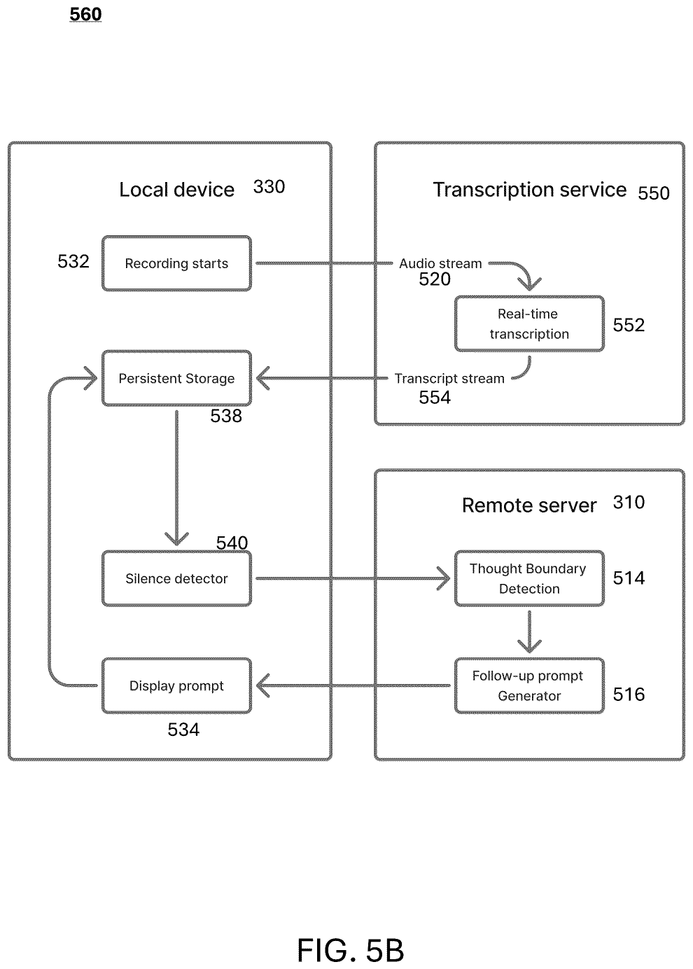

FIG. 6 illustrates a method 600 for processing media streams and extracting information from recorded content. The method 600 may be implemented by the recording processing system 110 and may work in conjunction with other components of the recording system 100 to transform raw recordings into structured information and insights.

The method 600 may include reconstructing 602 the media stream, where media chunks are reassembled into a continuous recording. Reconstruction may include ordering the chunks based on their sequence identifiers and combining them into a single, coherent media file. The reconstruction 602 may include validation procedures to ensure data integrity, such as verifying checksums and detecting any missing or corrupted segments.

The method 600 may include transcoding 604, where the media is converted into standardized formats for consistent processing. Transcoding 604 may include converting audio information from various input formats such as MP3, WAV, or AAC into a uniform format like FLAC or Opus. For video content, the transcoding may standardize the codec, resolution, and frame rate to ensure compatibility across different playback devices and processing systems.

The transcoded audio/video stream 606, maybe be packaged 608. Packaging 608 may include encapsulating the standardized media files along with associated metadata into container formats such as MKV or MP4. Packaging may facilitate efficient streaming, playback across different devices and platforms, and organization of the recorded content for long-term storage and retrieval.

Portions of the transcoded information may be further processed. For example, the audio stream 610 may be extracted from the transcoded content for transcription 612. Transcription 612 may convert the audio content to text using speech recognition algorithms and/or natural language processing techniques. Transcription may generate timestamped text segments that correspond to the user's spoken responses, creating a searchable and analyzable text representation of the recorded content.

The method 600 may include fact extraction 614 which includes analyzing the transcribed content to identify and extract concrete information such as names, dates, locations, events, and/or other factual details mentioned in the information. This extraction process may utilize named entity recognition techniques and large language models to systematically identify and categorize factual information within the text.

The method 600 may include insight extraction 616 which includes analyzing the transcribed content to derive higher-level observations about the user's communication patterns, emotional responses, and/or thematic elements. The insight extraction step 616 may employ sentiment analysis, topic modeling, and other natural language processing techniques to understand the user's storytelling style, preferred topics, and the effectiveness of different prompt types in eliciting detailed responses.

In some embodiments, insight extraction 616 may extend beyond textual analysis to incorporate direct processing of the audio and video data streams. The system may analyze acoustic features such as vocal pitch variations, speaking rate fluctuations, and pause patterns to infer emotional states and engagement levels that may not be captured in the transcript alone. Voice stress analysis techniques may be employed to detect tension, excitement, or hesitation in the user's responses, providing additional context for understanding the significance of particular topics or memories. When video data is available, insight extraction 616 may utilize computer vision algorithms to analyze facial expressions, body language, and gesture patterns, correlating these visual cues with the spoken content to develop a more comprehensive understanding of the user's emotional responses and communication style. The system may also examine audio-visual synchronization patterns, such as changes in eye contact with the camera or shifts in posture, to identify moments of particular emotional resonance or difficulty that could inform future prompt generation strategies.

The data extractions 614/616 may be performed in parallel. Alternatively, the data extractions 614/616 may occur linearly.

In some embodiments, the method 600 includes updating 618 the knowledge system 112 with the extracted information. Updating 618 may merge new facts with existing user knowledge, resolve any conflicts or inconsistencies, and update the user's profile with fresh insights about their communication preferences and inputs.

The method 600 may include prompt generation 620, which utilizes the updated user knowledge to create new prompts for future interactions. This step may leverage the accumulated facts and insights to generate more personalized and contextually relevant questions that are likely to elicit improved responses. The prompt generation 620 may also consider the effectiveness of previous prompts in generating detailed or emotional responses when crafting new questions.

The method 600 may implement quality control measures throughout the processing pipeline. In some cases, the system may perform confidence scoring on extracted facts and insights, allowing for more reliable information to be weighted more heavily in future prompt generation. The method 600 may also include error handling mechanisms to manage cases where transcription quality is poor or where extraction algorithms fail to identify meaningful content.

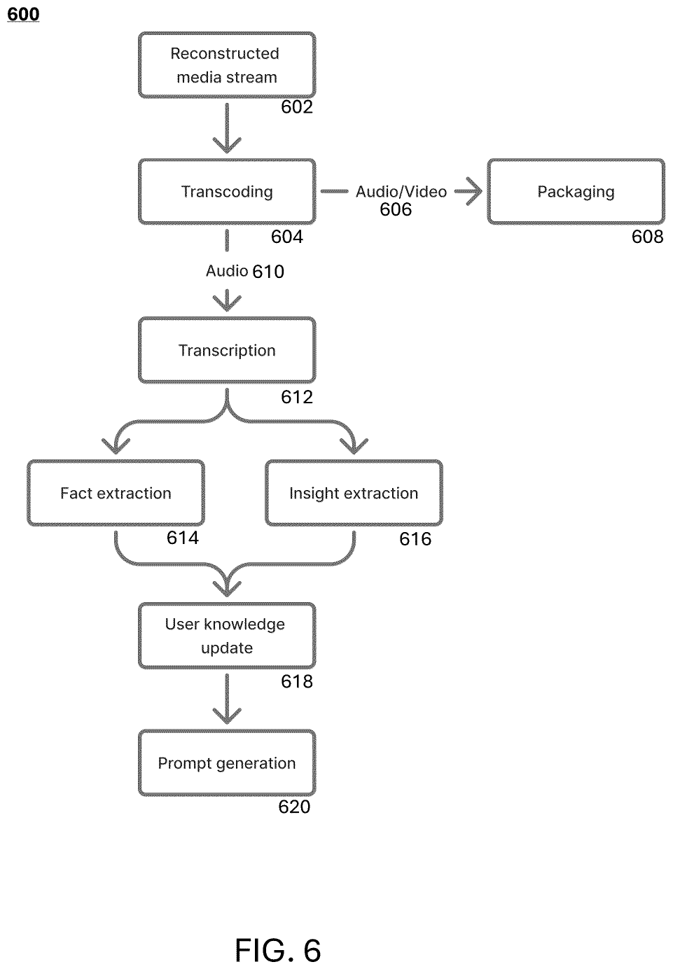

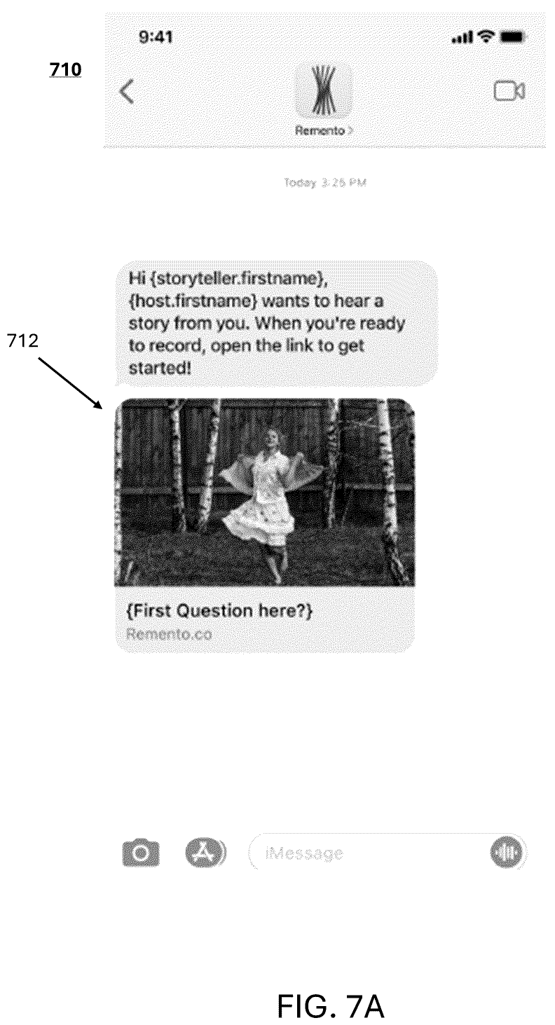

FIG. 7A illustrates a secondary communication user interface 710 that may be used to initiate a recording session. The secondary communication user interface 710 may display a messaging interface containing a link 712. The link 712 may include a prompt image and text, inviting a user to record their response to the prompt. In some cases, the link 712 may be generated by the authentication system 104 and may contain encoded session metadata for secure access to the recording interface 106. The secondary communication user interface may include a text message application, an email application/website, or any third-part communication system.

FIG. 7B shows a user interface 700 that may be presented to users when they access the recording interface 106. The user interface 700 may include several components designed to guide users through the recording process. A communication element 702 may display information about the current prompt and/or the actual question text. In some cases, the communication element 702 may present a prompt comprising at least one of a text question, an image, or a multimedia element 704.

The multimedia element 704 may display visual content related to the prompt, such as an image. In further embodiments, the multimedia element 704 may include an audio or video player. The multimedia element 704 may include multiple elements (e.g., in an album). This content may serve as a memory aid or conversation starter for the user.

The user interface 700 may include a recording thumbnail 706. The recording thumbnail 706 may show a preview of the current recording session, allowing users to see themselves as they record their response. The user interface 700 may include an interface element to initiate recording 708.

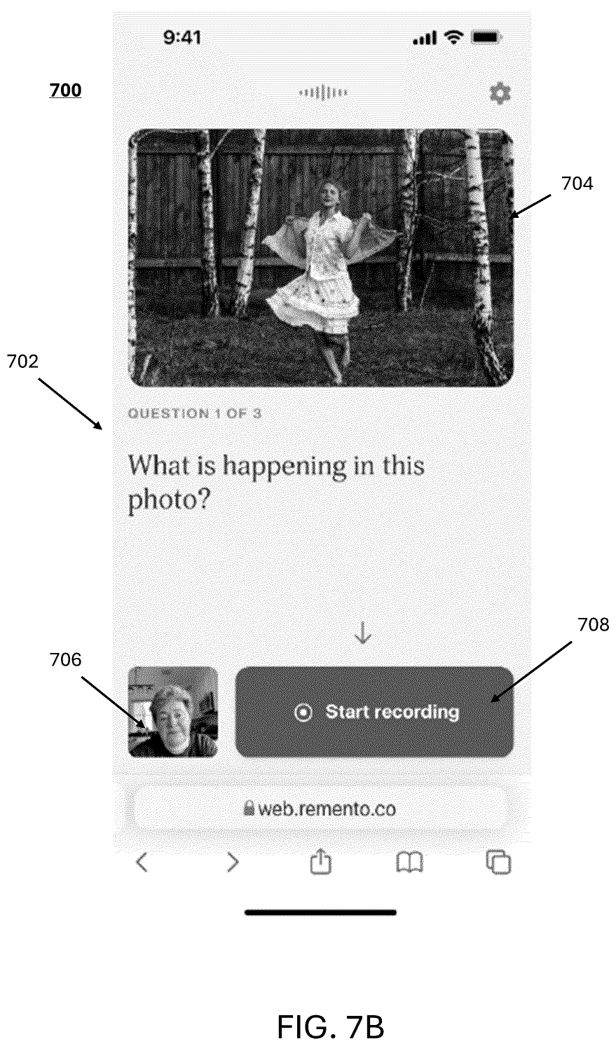

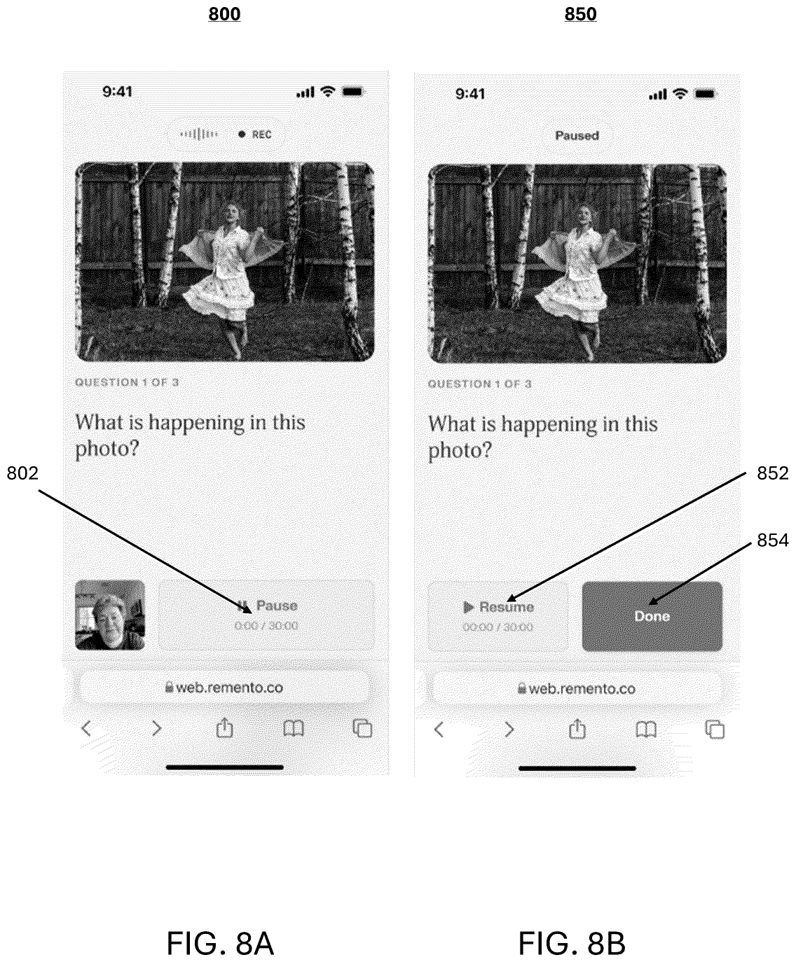

FIG. 8A and FIG. 8B illustrate recording user interfaces that may be presented during an active recording session. In FIG. 8A, a recording user interface 800 may display the recorded image along with the question prompt. The recording user interface 800 may include a pause button 802 positioned at the bottom of the screen, allowing users to temporarily stop the recording if needed.

FIG. 8B shows a recording user interface 850 that may be displayed when a recording session is paused. The recording user interface 850 may maintain visibility of the prompt and recorded content. A resume button 852 may be provided to allow users to continue recording. Additionally, a done button 854 may be included to enable users to complete and submit the recording session.

These user interfaces may work in conjunction with other components of the recording system 100. For example, the prompt management system 102 may provide the text and multimedia content displayed in the communication element 702 and multimedia element 704. The recording processing system 110 may handle the capture and storage of audio or video data when users interact with the recording button 708, pause button 802, or resume button 852. The interview system 108 may use the recorded content to generate follow-up prompts, which may be displayed in subsequent iterations of the user interface 700.

In some cases, the user interfaces may adapt based on the capabilities of the local device 330. For instance, the recording thumbnail 706 may only be displayed if the local device 330 supports video capture. The user interfaces may also be responsive to different screen sizes and orientations, ensuring a consistent experience across various devices.

The user interfaces described may provide a seamless and intuitive experience for users engaging with the recording system 100. By presenting prompts clearly, offering visual aids, and providing simple controls for managing the recording process, these interfaces may aid users focus on sharing information without being distracted by technical complexities.

The recording system may include additional components and processes to enhance its functionality and adaptability. In some cases, the system may implement a learning system that incrementally builds a structured model of the user's life and preferences by analyzing recorded interviews. This model may be composed of two primary outputs: facts, which are concrete assertions extracted from transcripts, and insights, which are higher-level observations about interview dynamics and question effectiveness.

In some cases, the model may incorporate a semantic network or knowledge graph structure to represent interconnections between people, places, events, and concepts mentioned in the storyteller's narratives. This network structure may allow for the identification of central themes, recurring motifs, and important relationships that shape the storyteller's life story. The edges in this graph may be weighted to reflect the strength of associations or the frequency with which certain connections are mentioned.

The model may also include a set of attribute vectors that capture various aspects of the user's personality, interests, and communication style. These vectors may represent dimensions such as openness to different types of questions, preferred topics of discussion, emotional expressiveness, and level of detail typically provided in responses. The system may update these attribute vectors over time as it gathers more data from multiple interview sessions.

In some implementations, the model may feature a hierarchical structure that organizes facts and insights at different levels of abstraction. Lower levels may contain specific, granular details extracted from individual stories, while higher levels may represent broader patterns, life themes, or overarching narratives that emerge from aggregating multiple anecdotes and observations. This hierarchical approach may allow the system to generate prompts and analyze responses at varying levels of specificity and abstraction.

The system may employ machine learning models, including large language models (LLMs), for fact extraction and insight extraction. In some cases, an LLM may receive existing factual knowledge along with a new transcript and extract new facts to merge into the existing list. Another LLM may review prompts used during the interview and the resulting information quality, emotional resonance, and specificity to generate revised insights that help guide future prompting strategies.

In some cases, the system may use a version-locked update mechanism to persist updated facts and insights to a user knowledge entity. This approach may avoid race conditions when multiple processes attempt to update the knowledge base simultaneously. The system may publish a change event to a dedicated topic when updates occur, triggering downstream processes to re-generate prompt suggestions.

In some embodiments, prompt generation may include fetching the most recent user knowledge entity and associated prompt history. An LLM may receive previously asked questions, existing prompt suggestions, current facts, and insights to generate new prompts tailored to the user. The system may parse these suggestions and update the database within a single atomic transaction, deleting outdated suggestions and inserting new ones.

In some cases, the system may support multiple simultaneous recording sessions. This scalability may allow for efficient collection of information from numerous participants concurrently, making the system suitable for large-scale oral history projects, social research initiatives, or organizational knowledge preservation efforts. In some embodiments, multiple sessions may be linked. Linked sessions may share some or all of the shared information for improved prompt generation across sessions.

The recording interface may implement robust error handling and recovery mechanisms. In some cases, if no media data event is received within a timeout window, the session may be considered stalled and automatically aborted. The system may notify the user that their recording has failed and provide options for recovery or restarting the session (e.g., via a signed URL).

The system may employ a chunked upload process to handle large amounts of data efficiently. In some cases, the system may define a buffer sized for optimal upload and storage performance. A buffer pointer may track the current position in the buffer where new data should be inserted. The upload process may slice the buffer, compute a checksum, and upload the slice to the backend. This approach may allow for efficient data transfer and integrity verification.

To prevent multiple recording processes from running simultaneously, the client may acquire a WebLock before initiating a session. The client may request the creation of a new Asset on the backend via HTTP. This asset may be returned with a unique ID and stored in the frontend's recording_sessions table in IndexedDB along with initial metadata such as status (RECORDING) and duration (0 milliseconds). Concurrently, a background uploader loop may be launched.

The client may also initiate a WebSocket connection to a third-party transcription engine. This connection may be used to stream audio data in real-time for live transcription purposes.

When media recording begins, the client may call mediaRecorder.start ( ) causing the browser to begin capturing encoded media data at fixed intervals. Each emitted chunk may result in the creation of a new media.data event, which may be pushed to a time-ordered, MessagePack-encoded event stream. This event stream may include structured control messages (session.start, media.start, media.stop) interleaved with binary payloads that contain audio/video fragments. Every new event may be stored in a table in IndexedDB, indexed by recordingID and a monotonically increasing sequenceID. This stream may be persisted incrementally to allow full recovery in the event of a browser crash or page reload.

A separate upload process may run continuously in the background. It may aggregate event stream items into binary chunks, compute a CRC32 checksum for each chunk, and/or upload them to the server via HTTP. Each upload may be tracked using a table, which records the next upload chunk index and the latest uploaded sequence ID. Once a chunk is successfully uploaded, the corresponding local entries in the table are deleted to free storage. This approach allows the application to record in the best quality available without concerns for the quality of the internet connection, while minimizing the use of persistent storage.

If no data is received from the MediaRecorder for a period of time (e.g., 10 seconds), the session may be considered stalled. The client may initiate a forced pause, perform cleanup, and/or update the session status to allow for recovery.

The system may support pause and resume semantics. When the user pauses, the client may emit a media.stop event, close the WebSocket connection to the transcription service, and clear the wake lock and health check timers. The session may be marked as PAUSED. To resume, the client may reacquire the wake lock, reopen the WebSocket connection, call mediaRecorder.resume ( ) and/or emit a new media.start event. This creates logically separate recording segments within a single session.

When the user ends the session, the system may perform a final pause if needed, update the session to FINISHED, and/or wait for all uploads to complete. The frontend may issue an HTTP request to the backend to process the recording, passing metadata including assetID, recordingID, and projectID.

On the backend, uploaded chunks may be validated by comparing their checksums. Duplicate uploads may be deduplicated and checksum mismatches may be rejected to ensure exactly-once delivery. Once all chunks are confirmed, the backend may invoke the object storage system's native compose operation to merge chunks into a single event stream blob.

This assembled object may be passed to an orchestration workflow. In the standardization phase, the event stream may be decoded, media fragments may be extracted and transcoded to a uniform format (H264/AAC inside MP4), and merged into a complete video. Additional assets such as audio-only WAV files and still-frame thumbnails may be derived using a video processing tool (e.g., ffmpeg).

In the packaging phase, a new worker may process the merged video into adaptive bitrate HLS segments. The segments and master playlist may be uploaded, and associated AssetAlternative entries are created in the database.

In the transcription phase, a signed URL to the audio asset may be sent to a third-party transcription provider. The resulting transcript may be parsed into timestamped segments and indexed by recordingID for downstream use.

Additional services such as summarization and knowledge extraction may be invoked. Once all processing is complete, the system may create a finalized recording entity linking the session metadata and all derived media assets.

This implementation provides a robust, fault-tolerant, zero-install recording experience that is accessible to non-technical users while ensuring media fidelity, session recoverability, and data integrity under variable network conditions.

In some cases, the system may implement robust data privacy and security measures. These may include end-to-end encryption for data transmission, secure storage of sensitive information, and granular access controls to ensure that personal information are protected and only accessible to authorized individuals or systems.

The system may incorporate multilingual capabilities to support information collection across different languages and cultures. This may involve language detection, real-time translation, and culturally sensitive prompt generation to ensure that the system can effectively capture and preserve diverse personal histories.

In some cases, the system may provide APIs or integration points to connect with external systems. This may include the export of collected information to other platforms, such as digital archives, museum exhibits, or educational resources, expanding the reach and impact of the preserved stories.

The system may implement mechanisms for continuous learning and improvement based on user feedback and system performance metrics. This may involve analyzing the quality and depth of collected information, user engagement levels, and the effectiveness of generated prompts to refine the system's algorithms and enhance its ability to elicit meaningful personal stories over time.

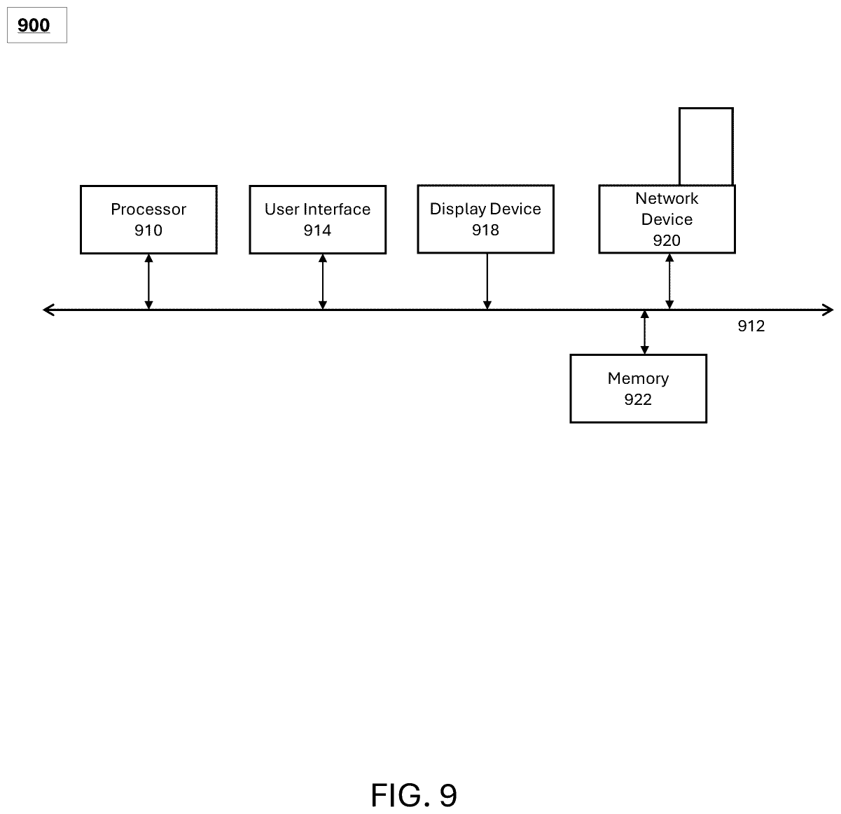

FIG. 9 shows an example computing device 900 which may be used in the systems and methods described herein and/or to implement the systems and methods described herein. In the example computer 900, a CPU or processor 910 is in communication, via a bus 912 or other communication, with a user interface 914. The user interface may include example input device such as a keyboard, mouse, touchscreen, button, joystick, or other user input device(s). The CPU 910 may interface to a display device 918 such as a screen. In some embodiments, the user interface 914 and/or the display device 918 may be related to an external device remotely interfaced to the computer 900. The computing device 900 shown in FIG. 9 also includes a network interface 920 which is in communication with the CPU 910 and other components. The network interface 920 may allow the computing device 900 to communicate with other computers, databases, networks, user devices, or any other computing capable devices. In some examples, additionally or alternatively, the method of communication may be through WIFI, cellular, Bluetooth Low Energy, wired communication, or any other kind of communication. In some examples, the computing device 900 includes a non-transitory memory 922 in communication with the processor 910. In some examples, additionally or alternatively, this memory 922 may include instructions to execute commands associated with the client or server processes described herein.

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Those having skill in the art can also translate from the plural form to the singular as is appropriate to the context and/or application. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices also can “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed:

1. A method comprising:
receiving, by a processor, a recording of a user response to a prompt;
transcribing, by the processor, the recording to generate a transcript;
analyzing, by the processor using a lightweight language model, the transcript and the prompt to determine whether the user response is complete;
in response to determining the user response is complete:
retrieving, by the processor, contextual information associated with the user;
generating, by the processor using a large language model, a follow-up prompt based on the transcript, the prompt, and the contextual information;
transmitting, by the processor, the follow-up prompt to a user device; and
receiving, by the processor, a second recording of a user response to the follow-up prompt.

2. The method of claim 1, wherein the contextual information includes historical data from previous recording sessions associated with the user.

3. The method of claim 1, further comprising:
analyzing, by the processor, emotional content of the user response using a machine learning model.

4. The method of claim 3, wherein generating the follow-up prompt further comprises:
utilizing, by the processor, the analyzed emotional content of the user response as input to the large language model to influence the generation of the follow-up prompt.

5. The method of claim 1, wherein the lightweight language model is optimized for low-latency processing of natural language input.

6. The method of claim 1, further comprising:
storing, by the processor, the transcript and the follow-up prompt in a knowledge base associated with the user.

7. The method of claim 1, wherein generating the follow-up prompt comprises:
identifying, by the large language model, key topics mentioned in the transcript; and formulating a question to elicit additional details about at least one of the key topics.

8. The method of claim 1, further comprising:
detecting, by the processor, a natural pause in the user response; and
wherein analyzing the transcript and the prompt to determine whether the user response is complete is performed in response to detecting the natural pause.

9. A system comprising:
a processor; and
a memory storing instructions that, when executed by the processor, cause the processor to:
receive a recording of a user response to a prompt;
transcribe the recording to generate a transcript;
analyze, using a lightweight language model, the transcript and the prompt to determine whether the user response is complete;
in response to determining the user response is complete:
retrieve contextual information associated with the user;
generate, using a large language model, a follow-up prompt based on the transcript, the prompt, and the contextual information;
transmit the follow-up prompt to a user device; and
receive a second recording of a user response to the follow-up prompt.

10. The system of claim 9, wherein the contextual information includes historical data from previous recording sessions associated with the user.

11. The system of claim 9, wherein the instructions further cause the processor to:
analyze emotional content of the user response using a machine learning model.

12. The system of claim 11, wherein generating the follow-up prompt further comprises:
utilizing the analyzed emotional content of the user response as input to the large language model to influence the generation of the follow-up prompt.

13. The system of claim 9, wherein the lightweight language model is optimized for low-latency processing of natural language input.

14. The system of claim 9, wherein the instructions further cause the processor to:
store the transcript and the follow-up prompt in a knowledge base associated with the user.

15. The system of claim 9, wherein generating the follow-up prompt comprises:
identifying, by the large language model, key topics mentioned in the transcript; and formulating a question to elicit additional details about at least one of the key topics.

16. The system of claim 9, wherein the instructions further cause the processor to:
detect a natural pause in the user response; and
wherein analyzing the transcript and the prompt to determine whether the user response is complete is performed in response to detecting the natural pause.

17. A non-transitory computer-readable medium storing instructions that, when executed by a processor, cause the processor to perform operations comprising:
receiving a recording of a user response to a prompt;
transcribing the recording to generate a transcript;
analyzing, using a lightweight language model, the transcript and the prompt to determine whether the user response is complete;
in response to determining the user response is complete:
retrieving contextual information associated with the user;
generating, using a large language model, a follow-up prompt based on the transcript, the prompt, and the contextual information;
transmitting the follow-up prompt to a user device; and
receiving a second recording of a user response to the follow-up prompt.

18. The non-transitory computer-readable medium of claim 17, wherein the contextual information includes historical data from previous recording sessions associated with the user.

19. The non-transitory computer-readable medium of claim 17, further comprising:
analyzing, by the processor, emotional content of the user response using a machine learning model.

20. The non-transitory computer-readable medium of claim 19, wherein generating the follow-up prompt further comprises:
utilizing, by the processor, the analyzed emotional content of the user response as input to the large language model to influence the generation of the follow-up prompt.
